(19) United States
(12) Patent Application Publication
(10) Pub. No.: US 2011/0254850 A1
(43) Pub. Date: Oct. 20, 2011

(54) IMAGE PROCESSING APPARATUS, DISPLAY SYSTEM, ELECTRONIC APPARATUS AND METHOD OF PROCESSING IMAGE

(75) Inventor: Kazuto KIKUTA, Hachioji-shi (JP)

(73) Assignee: SEIKO EPSON CORPORATION, Tokyo (JP)

(21) Appl. No.: 13/084,186

(22) Filed: Apr. 11, 2011

(30) Foreign Application Priority Data
Apr. 15, 2010 (JP) 2010-093761

(51) Int. Cl. G06F 13/14

(52) U.S. Cl. 345/520

(57) ABSTRACT

An image processing apparatus performing frame rate control on image data corresponding to each of dots forming a display image includes a frame rate generating section generating the frame rate of a dot according to a difference in gradation between the dot and a dot around the dot and a frame rate control section performing frame rate control on the image data on a dot-by-dot basis based on the frame rate.

The entire disclosure of Japanese Patent Application No. 2010-093761, filed Apr. 15, 2010, is expressly incorporated by reference herein.

### BACKGROUND

1. Technical Field

An aspect of the present invention relates to image processing apparatuses, display systems, electronic apparatuses, methods of processing an image.

2. Related Art

In recent years, as a display element, an LCD (Liquid Crystal Display: LCD) panel using a liquid crystal element and a display panel (a display unit) using an organic light emitting diode (Organic Light Emitting Diode: hereinafter abbreviated as an OLED) (in a broad sense, a light emitting device) have become widespread. In particular, the OLED responses faster than the liquid crystal element and can increase the contrast ratio. The display panel in which such OLEDs are arranged in a matrix has a wide viewing angle and can display a high-quality image.

On the other hand, in the display panel using the OLED, the organic material progressively deteriorates in proportion to the lighting time of the OLED due to the emission mechanism of the OLED. As a result, it is considered that such a display panel develops so-called burn-in, which tends to prevent the display panel from having a longer life as compared to other display panels such as an LCD panel. The techniques of preventing burn-in in the display panel using the OLED have been disclosed in JP-A-2007-304318 (Patent Document 1) and JP-A-2008-197626 (Patent Document 2), for example.

In Patent Document 1, an organic light emitting display device which moves a display position by a predetermined distance at specified time intervals while controlling the gradation of an image by the value of a current applied as an image signal or the amount of time for which a constant current is applied is disclosed. Moreover, in Patent Document 2, the technique of reducing a visual sign which appears when the refresh rate of a display is switched is disclosed.

However, the drawback of the techniques disclosed in Patent Document 1 and Patent Document 2 is that these techniques cannot shorten the lighting time of the OLED adequately. Moreover, the shortened lighting time lowers the brightness, leading to deterioration of image quality.

### SUMMARY

The invention has been made in view of the technical problems described above. According to some aspects of the invention, it is possible to provide an image processing apparatus, a display system, an electronic apparatus, a method of processing an image, etc. which can prevent deterioration of image quality associated with a decrease in brightness even when the lighting time of a display element such as an OLED is shortened.

(1) According to an aspect of the invention, an image processing apparatus performing frame rate control on image data corresponding to each of dots forming a display image includes a frame rate generating section generating the frame rate of a dot according to a difference in gradation between the dot and at least one dot around the dot and a frame rate control section performing frame rate control on the image data on a dot-by-dot basis based on the frame rate generated by the frame rate generating section.

According to this aspect, since frame rate control is performed on a dot-by-dot basis according to the difference in gradation between a dot and surrounding dots, it is possible to reduce the number of lighting as compared to when normal operation is performed, prevent the occurrence of burn-in, and thereby contribute to a longer life of a display panel. Furthermore, even when the lighting time of the dot is shortened, it is possible to prevent deterioration of image quality by frame rate control without simply lowering brightness.

(2) In the image processing apparatus according to another aspect of the invention, the frame rate generating section includes a frame rate adjustment processing section adjusting the frame rate based on at least one of a difference between the brightness of the dot and the brightness of a dot around the dot and a difference between the color value of the dot and the color value of a dot around the dot. According to this aspect, since the

frame rate is adjusted based on at least one of the difference between the brightness of the dot and the brightness of a dot around the dot and the difference between the color value of the dot and the color value of a dot around the dot, it is possible to use the brightness and the color value and simplify the frame rate adjustment processing performed on a dot-by-dot basis.

(3) In the image processing apparatus according to another aspect of the invention, the frame rate generating section corrects the frame rate of the dot, the frame rate generated according to the difference in gradation, in accordance with the average brightness of blocks forming a plurality of blocks into which the display image is divided.

In this aspect, the frame rate of each dot is corrected in accordance with the average brightness of blocks obtained by dividing the display image. As a result, by determining whether an image is a bright image or a dark image on a block-by-block basis and making a correction according to the determination result, it is possible to avoid a situation in which contrast is enhanced.

(4) In the image processing apparatus according to another aspect of the invention, the frame rate generating section generates the frame rate of the dot according to the difference in gradation between the dot and a dot around the dot while performing scanning corresponding to one screen on a processing block-by-processing block basis, a processing block being formed of three dots in a horizontal direction and three dots in a vertical direction of the display image, in the horizontal direction and in the vertical direction.

According to this aspect, it is possible to determine the frame rate while correlating the neighboring dots. This eliminates the possibility that the frame rate changes unnaturally between the neighboring dots, and makes it possible to prevent deterioration of image quality caused by adjustment of the frame rate.

(5) In the image processing apparatus according to another aspect of the invention, the frame rate control section performs frame rate control on the image data on a dot-by-dot basis when the display image is a still image.

According to this aspect, it is possible to prevent deterioration of image quality of moving images by not performing control on moving images on which frame rate control has little effect and prevent burn-in reliably, and improve the image quality at the time of image display at which the lighting time becomes longer.

(6) The image processing apparatus according to another aspect of the invention includes a gamma correction processing section performing gamma correction processing on the image data on which frame rate control has been performed by the frame rate control section.

According to this aspect, in addition to the above-described effects, it is possible to prevent deterioration of image quality even if there is a decrease in the brightness of the whole image or color loss occurs as a result of frame rate control.

(7) According to another aspect of the invention, a display system includes: a display panel including a plurality of row signal lines, a plurality of column signal lines provided so as to intersect the plurality of row signal lines, and a plurality of light emitting devices, each being identified by any one of the plurality of row signal lines and any one of the plurality of column signal lines and emitting light at brightness according to a drive current; a row driver driving the plurality of row signal lines; a column driver driving the plurality of column signal lines; and the image processing apparatus described in any one of the above aspects, and the display system displays the display image based on the image data on which frame rate control has been performed by the image processing apparatus.

According to this aspect, it is possible to provide a display system which can prevent deterioration of image quality associated with a decrease in brightness even when the lighting time of a display element is shortened.

(8) According to another aspect of the invention, an electronic apparatus includes the image processing apparatus described in any one of the above aspects.

According to this aspect, it is possible to provide an electronic apparatus provided with an image processing apparatus which can prevent deterioration of image quality associated with a decrease in brightness even when the lighting time of a display element is shortened.

(9) According to another aspect of the invention, a method of processing an image, the method by which frame rate control is performed on image data corresponding to each of dots forming a display image, includes: a frame rate generating step of generating the frame rate of a dot according to a difference in gradation between the dot and at least one dot around the dot; and a frame rate control step of performing frame rate control on the image data on a dot-by-dot basis at the frame rate generated in the frame rate generating step.

According to this aspect, since frame rate control is performed on a dot-by-dot basis according to the difference in gradation between a dot and surrounding dots, it is possible to reduce the number of lighting as compared to when normal operation is performed, prevent the occurrence of burn-in, and thereby contribute to a longer life of the display panel. Furthermore, even when the lighting time of the dot is shortened, it is possible to prevent deterioration of image quality by frame rate control without simply lowering brightness.

(10) In the method of processing an image according to another aspect of the invention, in the frame rate generating step, the frame rate is adjusted based on at least one of a difference between the brightness of the dot and the brightness of a dot around the dot and a difference between the color value of the dot and the color value of a dot around the dot.

According to this aspect, since the frame rate is adjusted based on at least one of the difference between the brightness of the dot and the brightness of a dot around the dot and the difference between the color value of the dot and the color value of a dot around the dot, it is possible to use the brightness and the color value and simplify the frame rate adjustment processing performed on a dot-by-dot basis.

(11) In the method of processing an image according to another aspect of the invention, in the frame rate generating step, the frame rate of the dot, the frame rate generated according to the difference in gradation, is corrected in accordance with the average brightness of blocks forming a plurality of blocks into which the display image is divided.

In this aspect, the frame rate of each dot is corrected in accordance with the average brightness of blocks obtained by dividing the display image. As a result, by determining whether an image is a bright image or a dark image on a block-by-block basis and making a correction according to the determination result, it is possible to avoid a situation in which contrast is enhanced.

(12) In the method of processing an image according to another aspect of the invention, in the frame rate generating step, the frame rate of the dot is generated according to the difference in gradation between the dot and a dot around the dot while performing scanning corresponding to one screen on a processing block-by-processing block basis, a processing block being formed of three dots in a horizontal direction and three dots in a vertical direction of the display image, in the horizontal direction and in the vertical direction.

According to this aspect, it is possible to determine the frame rate while correlating the neighboring dots. This eliminates the possibility that the frame rate changes unnaturally between the neighboring dots, and makes it possible to prevent deterioration of image quality caused by adjustment of the frame rate.

### BRIEF DESCRIPTION OF THE DRAWINGS

FIG. 1 shows a block diagram of a configuration example of a display system according to an embodiment of the invention.

FIG. 2 shows a block diagram of a configuration example of an image processing apparatus of FIG. 1.

FIG. 3 shows a block diagram of a configuration example of an image analyzing section of FIG. 2.

FIG. 4 shows a block diagram of a configuration example of an FRC section of FIG. 2.

FIG. 5 shows a diagram explaining the operation of the image processing apparatus.

FIG. 6 shows another diagram explaining the operation of the image processing apparatus.

FIG. 7 shows a flow diagram of an example of processing performed by the image processing apparatus.

FIG. 8 shows a diagram schematically showing an example of a base frame rate table.

FIG. 9 shows a diagram schematically showing an example of a base frame rate addition table.

FIG. 10 shows a diagram schematically showing an example of a brightness difference frame rate addition table.

FIG. 11 shows a diagram schematically showing an example of a color distance frame rate addition table.

FIGS. 12(A) to 12(C) are diagrams showing a specific example of brightness obtained for each dot in a processing block.

FIGS. 13(A) and 13(B) are diagrams showing an example of the base frame rate corresponding to the brightness of FIG. 12(C).

FIGS. 14(A) and 14(B) are diagrams showing a brightness difference and a color distance between a dot D5 and surrounding dots, (the brightness difference and the color distance calculated in a frame rate adjustment processing section.

FIGS. 15(A) to 15(C) are diagrams showing an example of the frame rates of dots, the frame rates generated in a frame rate generating section.

FIGS. 16(A) and 16(B) are perspective views showing the configurations of electronic apparatuses to which a display system in this embodiment is applied.

### DETAILED DESCRIPTION OF EXEMPLARY EMBODIMENTS

Hereinafter, an embodiment of the invention will be described in detail by using the drawings. It is to be understood that the invention described in the claims is not unduly limited by the embodiment thereof described below. Moreover, all the configurations described below are not always the component elements necessary for solving the problems of the invention.

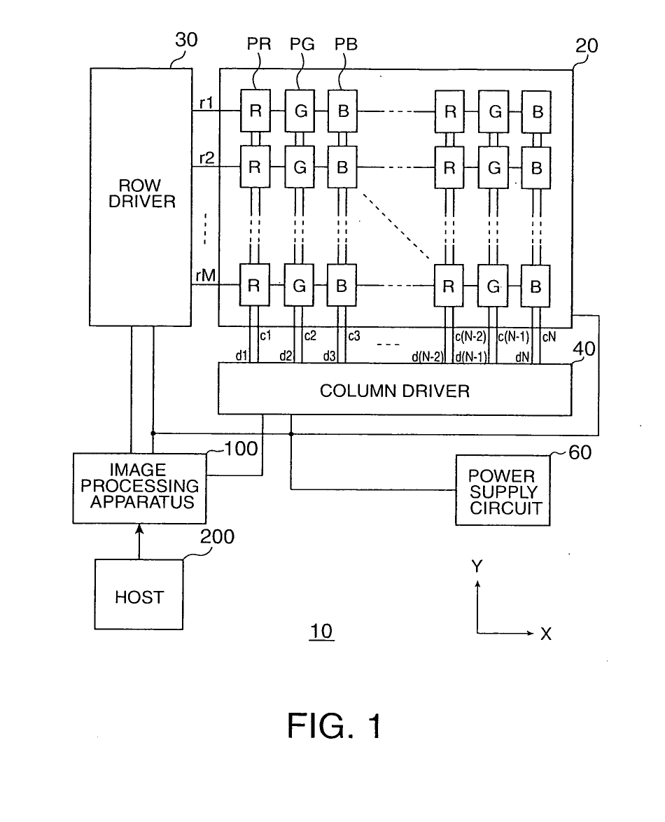

In FIG. 1, a block diagram of a configuration example of a display system according to an embodiment of the invention is shown. The display system has a display panel (a light emitting panel) using OLEDs, each being a light emitting device as a display element, and each OLED is driven by a row driver and a column driver based on image data and a display timing control signal which are generated by an image processing apparatus.

More specifically, a display system 10 includes a display panel 20, a row driver 30, a column driver 40, a power supply circuit 60, an image processing apparatus 100, and a host 200. In the display panel 20, a plurality of data signal lines d1 to dN (N is an integer greater than or equal to 2) and a plurality of column signal lines c1 to cN which extend in the Y direction are arranged in the X direction. Furthermore, in the display panel 20, a plurality of row signal lines r1 to rM (M is an integer greater than or equal to 2) extending in the X direction so as to intersect the column signal lines and the data signal lines are arranged in the Y direction. In the positions where the column signal lines (more specifically, the column signal lines and the data signal lines) and the row signal lines intersect each other, pixel circuits are formed, and a plurality of pixel circuits are arranged in a matrix in the display panel 20.

In FIG. 1, a pixel circuit PR of an R component, a pixel circuit PG of a G component, and a pixel circuit PB of a B component, which are neighboring pixel circuits in the X direction, form one dot. The pixel circuit PR of the R component has an OLED emitting a red display color, the pixel circuit PG of the G component has an OLED emitting a green display color, and the pixel circuit PB of the B component has an OLED emitting a blue display color.

The row driver 30 is connected to the row signal lines r1 to rM of the display panel 20. The row driver 30 selects the row signal lines r1 to rM of the display panel 20 one at a time within one vertical scanning period, for example, and outputs a selection pulse in a selection period of each row signal line. The column driver 40 is connected to the data signal lines d1 to dN and the column signal lines c1 to cN of the display panel 20. The column driver 40 applies a given power supply voltage to the column signal lines c1 to cN, and applies a gradation voltage corresponding to the image data of one line to each data signal line in each horizontal scanning period, for example.

As a result, in a horizontal scanning period in which the j (1≦j≦M, j is an integer)-th row is selected, a gradation voltage corresponding to the image data is applied to a pixel circuit in the k (1≦k≦N, k is an integer)-th column of the j-th row. In the pixel circuit in the k-th column of the j-th row, when a selection pulse is applied to a row signal line rj, a voltage corresponding to the image data, the voltage applied to a data signal line dk, is supplied to the gate of a driving transistor of the pixel circuit. That is, when a selection pulse is applied to the row signal line rj by the row driver 30, a voltage corresponding to the image data, the voltage applied to the data signal line dk by the column driver 40, is supplied to the gate of the driving transistor. At this time, when a given power supply voltage is applied to a column signal line ck, the driving transistor is brought into a conducting state, and a drive current flows through the OLED of the pixel circuit. As described above, the row driver 30 and the column driver 40 can supply a drive current corresponding to the image data to the OLEDs forming the pixels connected to the row signal lines selected one at a time within one vertical scanning period.

As an image data generating section, the host 200 generates image data corresponding to a display image. The image data generated by the host 200 is sent to the image processing apparatus 100. At the time of image display based on the image data from the host 200, the image processing apparatus 100 performs frame rate control (Frame Rate Control: hereinafter FRC) on the image data. The image data subjected to FRC by the image processing apparatus 100 is supplied to the column driver 40. Moreover, a display timing control signal corresponding to the image data subjected to FRC by the image processing apparatus 100 is supplied to the row driver 30 and the column driver 40. The power supply circuit 60 generates a plurality of types of power supply voltages and supplies the power supply voltages to individual parts of the display panel 20, the row driver 30, the column driver 40, and the image processing apparatus 100.

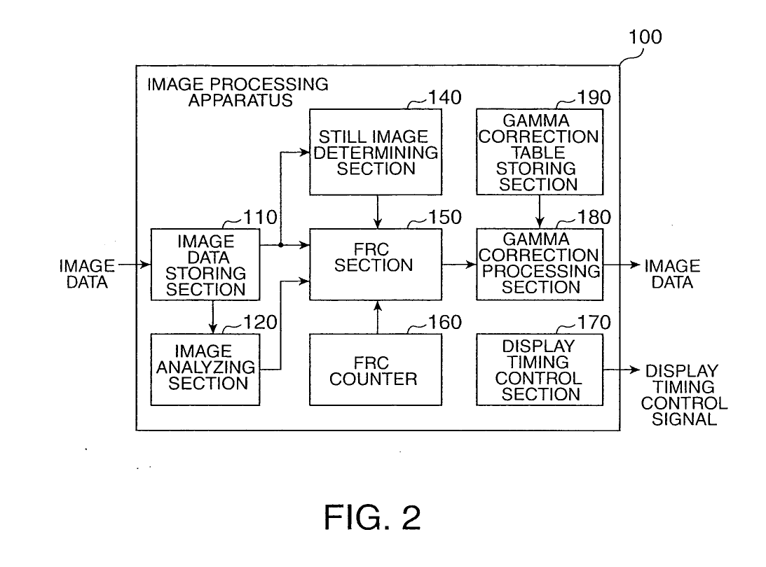

In FIG. 2, a block diagram of a configuration example of the image processing apparatus 100 of FIG. 1 is shown.

The image processing apparatus 100 includes an image data storing section 110, an image analyzing section 120, a still image determining section 140, an FRC section (a frame rate control section) 150, an FRC counter 160, and a display timing control section 170. Furthermore, the image processing apparatus 100 includes a gamma correction processing section 180 and a gamma correction table storing section 190.

The image data storing section 110 stores image data of each of dots forming a display image generated by the host 200. In the image data storing section 110, image data from the host 200 is sequentially stored.

The image analyzing section 120 functions as a frame rate generating section, and generates a frame rate for each dot based on the image data stored in the image data storing section 110. The image analyzing section 120 generates the frame rate of each dot according to the difference in gradation between each dot and at least one dot around the dot. More specifically, the image analyzing section 120 determines a base frame rate according to the brightness of the dot. The base frame rate is corrected according to the average brightness of the brightness of a plurality of dots forming a given block including the dot. Then, the image analyzing section 120 generates a frame rate for each dot, the frame rate obtained by adjusting the base frame rate (or the base frame rate corrected according to the average brightness) according to the difference in gradation between the dot and surrounding dots. That is, the image analyzing section 120 generates a frame rate for each dot based on at least one of the difference (the brightness difference) between the brightness of the dot and the brightness of a dot around the dot and the difference (the color distance) between the color value of the dot and the color value of a dot around the dot. Here, the color value simply has to be a value representing a color. In this way, the frame rate generated for each dot is associated with the image data of the dot and is stored in the image analyzing section 120 or the image data storing section 110.

The still image determining section 140 determines whether or not the image data supplied from the host 200 is the image data of a still image. For this purpose, the still image determining section 140 detects whether or not there is a series of frames in which an image to be displayed is a still image based on the image data sequentially stored in the image data storing section 110. If it is detected that there is a series of frames which are still images, the still image determining section 140 determines that the image data from the host 200 is the image data of a still image.

The FRC section 150 performs FRC on the image data of each dot, the image data which is stored in the image data storing section 110, based on the frame rate generated for each dot by the image analyzing section 120. Such an FRC section 150 performs FRC described above when the still image determining section 140 determines that the image data to be processed is the image data of a still image. This makes it possible to prevent deterioration of image quality of moving images by not performing control on moving images on which FRC has little effect and prevent burn-in reliably, and improve the image quality at the time of image display at which the lighting time becomes longer. The FRC counter 160 generates a frame number FN which is referred to in FRC performed by the FRC section 150. The FRC counter 160 counts the number of frames of an image subjected to display control, and outputs a frame number FN for identifying the counted frame. The FRC section 150 performs FRC by using the frame number FN from the FRC counter 160.

The display timing control section 170 generates a display timing control signal. As the display timing control signal, there are, for example, a horizontal synchronizing signal HSYNC specifying one horizontal scanning period, a vertical synchronizing signal VSYNC specifying one vertical scanning period, a start pulse STH in a horizontal scanning direction, a start pulse STV in a vertical scanning direction, a dot clock DCLK, and the like. The display timing control signal generated by the display timing control section 170 is synchronized with the image data subjected to FRC performed by the FRC section 150 and is output to the row driver 30 and the column driver 40.

The gamma correction processing section 180 performs gamma correction processing on the image data subjected to FRC performed by the FRC section 150 according to a gamma correction table stored in the gamma correction table storing section 190. In the gamma correction table, a gamma correction amount corresponding to the image data before correction is stored as correction data, and the gamma correction processing section 180 performs processing for correcting the image data based on the correction data corresponding to the image data subjected to FRC. The correction data forming the gamma correction table stored in the gamma correction table storing section 190 is configured so that it can be changed by the host 200 or the like.

Incidentally, in FIG. 2, a configuration in which the image processing apparatus 100 incorporates the image data storing section 110 is shown as an example; however, the image data storing section 110 may be provided outside the image processing apparatus 100. Moreover, the image data of each dot and the frame rate corresponding to the image data which are stored in the image data storing section 110 may be spread among a plurality of storage means and stored therein.

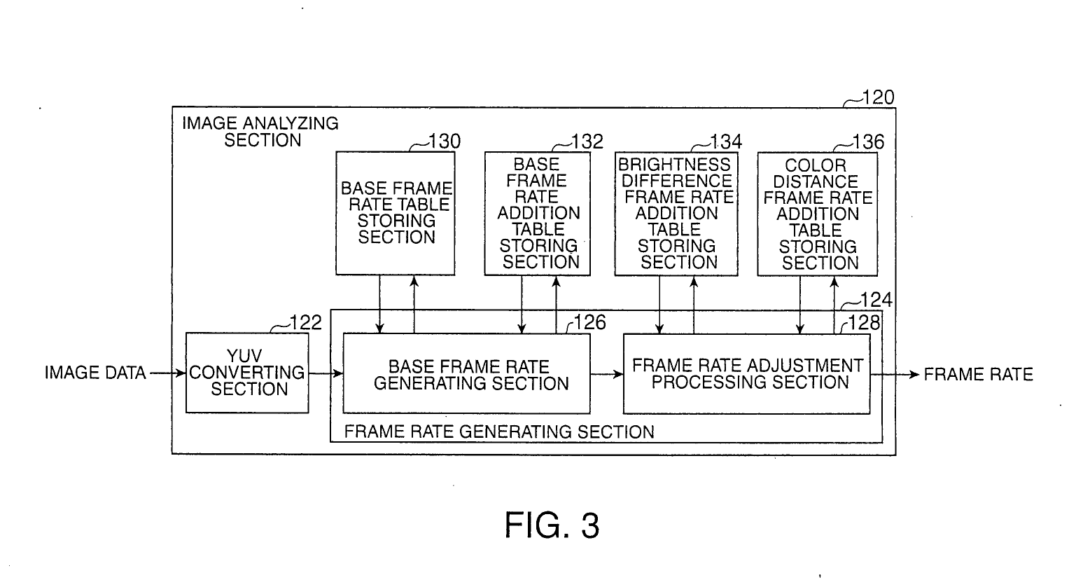

In FIG. 3, a block diagram of a configuration example of the image analyzing section 120 of FIG. 2 is shown. In FIG. 3, parts which are identical to those in FIG. 2 are identified with the same reference numerals, and their explanations will be appropriately omitted.

The image analyzing section 120 includes a YUV converting section 122 and a frame rate generating section 124. The frame rate generating section 124 includes a base frame rate generating section 126 and a frame rate adjustment processing section 128. Moreover, to change the frame rate generated in the frame rate generating section 124 according to the brightness of the dot and the difference in gradation between the dot and dots around the dot, the image analyzing section 120 refers to a plurality of types of tables. That is, the image analyzing section 120 includes a base frame rate table storing section 130, a base frame rate addition table storing section 132, a brightness difference frame rate addition table storing section 134, and a color distance frame rate addition table storing section 136.

The YUV converting section 122 converts the image data (for example, the image data in RGB format) stored in the image data storing section 110 into YUV data formed of brightness data Y and color-difference data UV. The frame rate generating section 124 generates the frame rate of the dot according to the difference in gradation between the dot and at least one dot around the dot. At this time, the frame rate generating section 124 generates the frame rate by using the brightness data converted by the YUV converting section 122 and the image data in RGB format, for example.

Such a frame rate generating section 124 generates a base frame rate in the base frame rate generating section 126 by referring to the base frame rate table stored in the base frame rate table storing section 130. In the base frame rate table, a frame rate corresponding to the brightness of the dot is stored, and the base frame rate generating section 126 generates a base frame rate corresponding to the brightness of the dot by referring to the base frame rate table. Moreover, the frame rate generating section 124 corrects the base frame rate by referring to the base frame rate addition table stored in the base frame rate addition table storing section 132. By doing so, it is possible to prevent contrast from being further enhanced as a result of the difference in frame rate becoming large in an image in which both ends in a horizontal direction are bright or an image in which both ends in a horizontal direction are dark, for example. That is, by determining whether an image is a bright image or a dark image on a block-by-block basis in such an image and making a correction according to the results of determination, a situation in which contrast is enhanced is avoided. In the base frame rate addition table, an additional value (correction data) corresponding to the average brightness of a block formed of a plurality of dots including the dot is stored. The base frame rate generating section 126 corrects the base frame rate by referring to the base frame rate addition table.

The frame rate adjustment processing section 128 performs processing for adjusting the base frame rate. For this purpose, the frame rate adjustment processing section 128 refers to at least one of the brightness difference frame rate addition table and the color distance frame rate addition table. In the brightness difference frame rate addition table stored in the brightness difference frame rate addition table storing section 134, an additional value (correction data) corresponding to the brightness difference between a dot and surrounding dots is stored. In the color distance frame rate addition table stored in the color distance frame rate addition table storing section 136, an additional value (correction data) corresponding to the color distance between a dot and surrounding dots is stored.

As described above, the base frame rate generating section 126 generates a base frame rate for each dot, the base frame rate according to the brightness of each dot. Moreover, the frame rate adjustment processing section 128 adjusts the base frame rate according to at least one of the brightness difference and the color distance between the dot and surrounding dots.

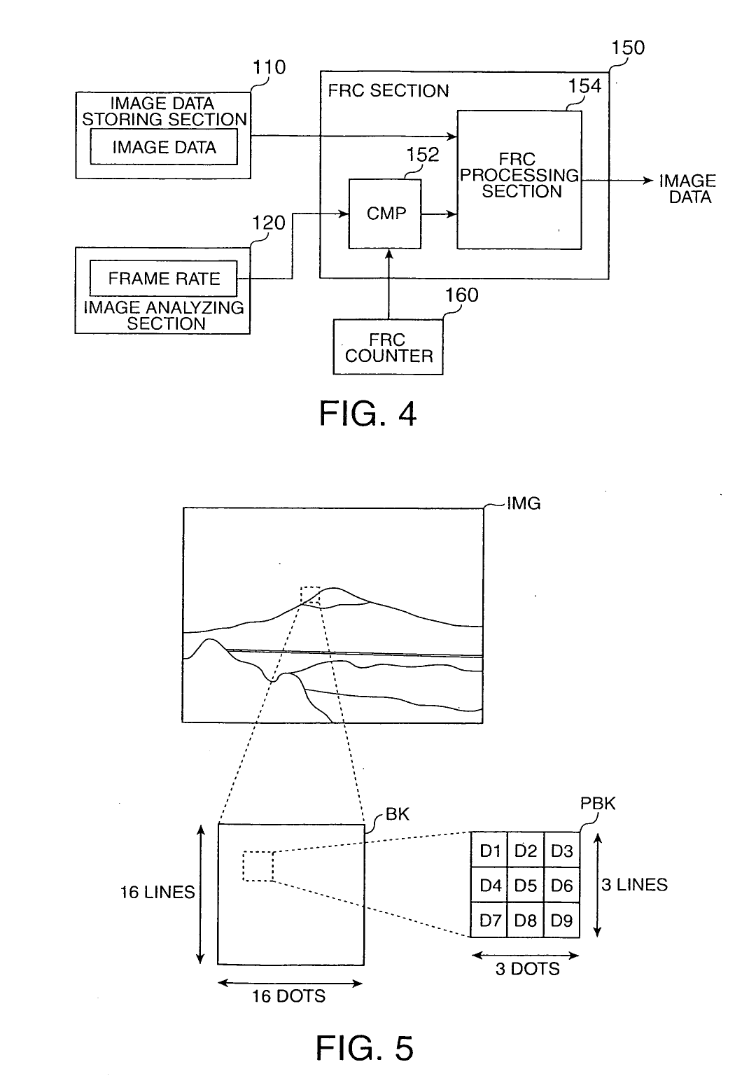

In FIG. 4, a block diagram of a configuration example of the FRC section 150 of FIG. 2 is shown. In addition to the FRC section 150, FIG. 4 also shows the image data storing section 110, the image analyzing section 120, and the FRC counter 160. In FIG. 4, parts which are identical to those in FIG. 2 are identified with the same reference numerals, and their explanations will be appropriately omitted.

The FRC section 150 has a comparator 152 and an FRC processing section 154, and performs FRC based on the image data stored in the image data storing section 110 and the frame rate corresponding to the image data. The frame rate corresponding to the image data of each dot is obtained in the image analyzing section 120 prior to FRC. The comparator 152 compares the frame number FN from the FRC counter 160 and the frame rate of the dot. The FRC processing section 154 performs FRC processing on the image data of the dot, the image data stored in the image data storing section 110, based on the comparison result from the comparator 152. In the FRC processing, it is determined whether the dot is to be lit or not to be lit with reference to the frame rate of the dot. When the dot is lit, the FRC processing section 154 outputs the image data of the dot as it is. On the other hand, when the dot is not lit, the FRC processing section 154 outputs image data which displays black as the image data of the dot. In this way, by performing control so as to light or not to light a dot based on the frame rate generated for each dot, the image processing apparatus 100 realizes FRC.

An example of the operation of the image processing apparatus 100 having the configuration described above will be described.

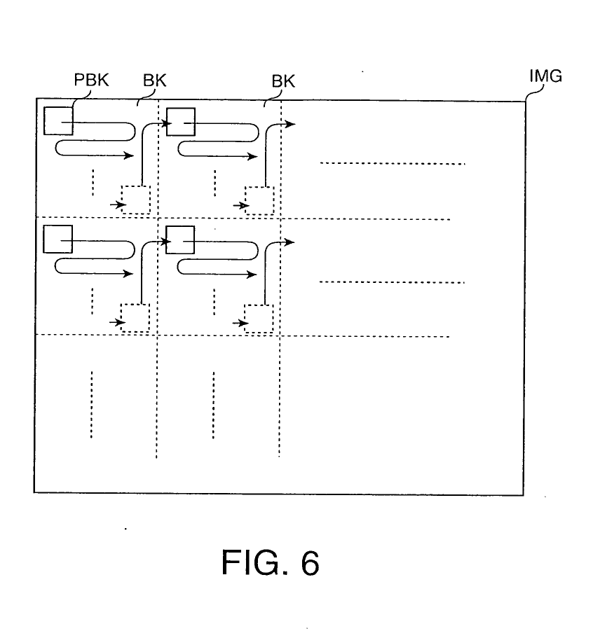

In FIGS. 5 and 6, diagrams explaining the operation of the image processing apparatus 100 are shown. FIG. 5 is an explanatory diagram of a unit of processing of FRC performed on image data corresponding to a display image IMG. FIG. 6 is an explanatory diagram of scanning of the unit of processing of FIG. 5.

As shown in FIG. 5, the image processing apparatus 100 performs FRC block BK by block BK which is obtained by dividing the display image IMG into a plurality of blocks. In this embodiment, the block BK is a rectangular region formed of 16 dots×16 lines, and the average brightness is generated on a block BK-by-block BK basis. At this time, the image processing apparatus 100 determines the frame rate of each dot according to the difference in gradation between the dot and surrounding dots on a processing block PBK (a processing block formed of three dots in a horizontal direction and three dots in a vertical direction)-by-processing block PBK basis, the processing block PBK which is formed of 3 dots×3 lines of each block BK. That is, as shown in FIG. 6, the image processing apparatus 100 generates the frame rate of each dot by dividing the display image IMG into a plurality of blocks and repeatedly performing scanning while shifting the processing block PBK in each block BK on a dot-by-dot basis or on a line-by-line basis. As described above, by forming the processing block PBK as 3 dots×3 lines and generating a frame rate according to the difference in gradation between the dots while shifting the processing block PBK on a dot-by-dot basis or on a line-by-line basis, it is possible to determine the frame rate while correlating the neighboring dots. This eliminates the possibility that the frame rate changes unnaturally between the neighboring dots, and makes it possible to prevent deterioration of image quality caused by adjustment of the frame rate.

Hereinafter, a specific example of processing performed by the image processing apparatus 100 will be described.

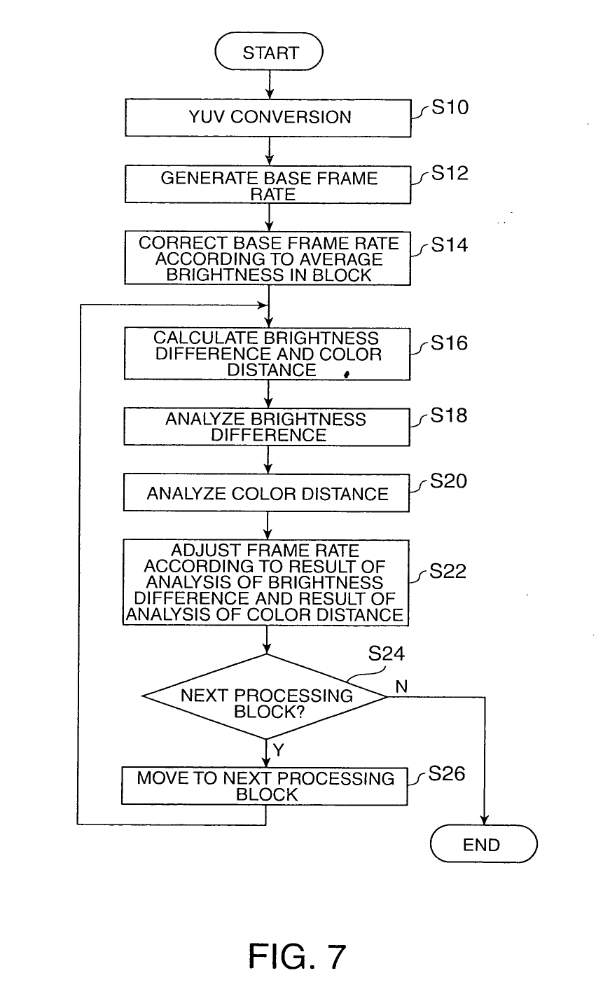

In FIG. 7, a flow diagram of an example of processing performed by the image processing apparatus 100 is shown. The image processing apparatus 100 is formed of an ASIC (Application Specific Integrated Circuit) and dedicated hardware, and hardware corresponding to the individual parts of FIGS. 2 to 4 can execute processing corresponding to the steps of FIG. 7. Alternatively, the image processing apparatus 100 may be formed of a central processing unit (Central Processing Unit: hereinafter CPU) and a read only memory (Read Only Memory: hereinafter ROM) or random access memory (Random Access Memory: hereinafter RAM). In this case, the CPU which has read a program product stored in the ROM or the RAM executes the processing corresponding to the program product, whereby the processing corresponding to the steps of FIG. 7 can be executed.

Prior to FRC performed by the image processing apparatus 100, the tables: the base frame rate table, the base frame rate addition table, the brightness difference frame rate addition table, and the color distance frame rate addition table are created. For example, the host 200 may set the values of the tables. Here, for example, when image data of the display image IMG shown in FIG. 5, the image data in RGB format, is input, the image processing apparatus 100 stores the image data in the image data storing section 110. The image processing apparatus 100 sets a processing block at the upper-left corner of the first block, and determines the frame rate of each dot on a processing block-by-processing block basis while shifting the processing block in the block on a dot-by-dot basis in a horizontal direction or on a line-by-line basis in a vertical direction. The image processing apparatus 100 repeats this processing for each block, and determines the frame rate of each dot of the display image IMG.

For that purpose, first, the image processing apparatus 100 reads the image data of each dot from the image data storing section 110 and converts the image data into YUV data in the YUV converting section 122 of the image analyzing section 120 (step S10). Next, the frame rate generating section 124 creates a brightness histogram on a block BK-by-block BK basis, the block BK of FIG. 5 or 6. Then, the base frame rate generating section 126 generates,the base frame rate of each dot by reading a base frame rate fr corresponding to the brightness of each dot by referring to the base frame rate table storing section 130 (step S12). Moreover, the base frame rate generating section 126 corrects the base frame rate of each dot on a block-by-block basis by reading an additional value δ corresponding to the average brightness of the block BK including the dot by referring to the base frame rate addition table storing section 132 (step S14). By making a correction according to the brightness in each block in step S14, it is possible to prevent contrast from being unduly enhanced.

Then, the image processing apparatus 100 performs the following processing in the processing block PBK for each block BK. That is, the frame rate generating section 124 calculates the brightness differences between the dots adjacent to each other in horizontal, vertical, and oblique directions, and calculates the color distances (the differences between the values representing the colors of the dots) between the dots (step S16). Then, the frame rate adjustment processing section 128 analyzes the brightness differences and color distances (step S18 and step S20), and, based on the analysis results, performs processing for adjusting the base frame rate generated in the base frame rate generating section 126 (step S22). More specifically, based on the brightness difference analysis results, the frame rate adjustment processing section 128 reads an additional value α according to the brightness difference by referring to the brightness difference frame rate addition table storing section 134, and adjusts the frame rate of each dot in the processing block PBK. Moreover, based on the color distance analysis results, the frame rate adjustment processing section 128 reads an additional value β according to the color distance by referring to the color distance frame rate addition table storing section 136, and adjusts the frame rate of each dot in the processing block PBK. As a result, by reducing the frame rate, the difference between bright and dark dots, which are inherently different in brightness, is prevented from becoming prominent.

Then, if there is a next processing block (step S24: Y), the image processing apparatus 100 moves an object to be processed to the next processing block by shifting the position of the processing block by one dot in a horizontal direction or by one line in a vertical direction (step S26), and goes back to step S16. Moreover, if there is no next processing block in step S24 (step S24: N), the image processing apparatus 100 ends a series of processes (END).

Incidentally, in FIG. 7, an example in which both the brightness difference and the color distance are analyzed is shown; however, only one of the brightness difference and the color distance may be analyzed, and the frame rate may be adjusted according to the analysis result.

Here, an example of processing performed by the image processing apparatus 100 will be described specifically. Hereinafter, it is assumed that the tables: the base frame rate table, the base frame rate addition table, the brightness difference frame rate addition table, and the color distance frame rate addition table are set as follows.

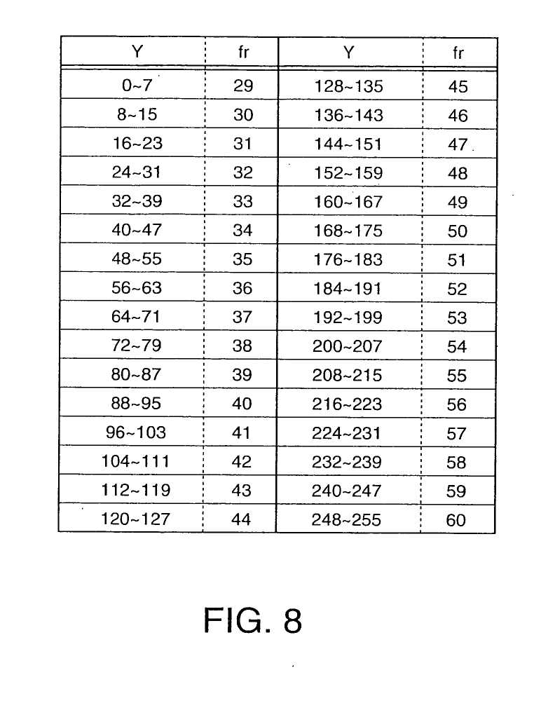

In FIG. 8, an example of the base frame rate table stored in the base frame rate table storing section 130 is schematically shown. In the base frame rate table, a base frame rate fr is specified for the brightness (Y) of each dot. Incidentally, in FIG. 8, an example in which a base frame rate is specified for every 8 brightness values is shown. However, it is preferable that the number of brightness values for which one base frame rate fr is specified and the value of the base frame rate fr can be changed according to the characteristics etc. of the display panel 20.

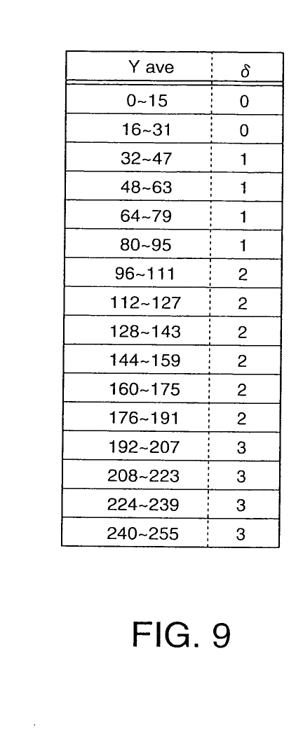

In FIG. 9, an example of the base frame rate addition table stored in the base frame rate addition table storing section 132 of FIG. 3 is schematically shown. In the base frame rate addition table, an additional value δ is specified for the average brightness (Yave) in a block BK. Incidentally, in FIG. 9, an example in which an additional value δ is specified for every 16 average brightness values is shown. However, it is preferable that the number of average brightness values for which one additional value δ is specified and the value of the additional value δ can be changed according to the characteristics etc. of the display panel 20.

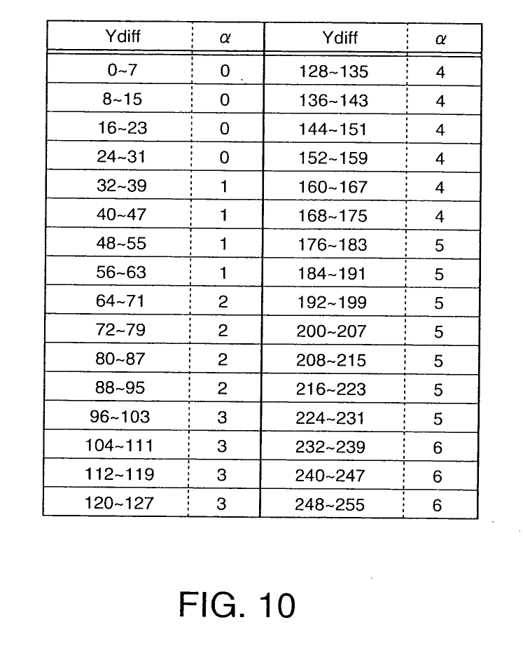

In FIG. 10. an example of the brightness difference frame rate addition table stored in the brightness difference frame rate addition table storing section 134 of FIG. 3 is schematically shown. In the brightness difference frame rate addition table, an additional value α is specified for a brightness difference (Ydiff). Incidentally, in FIG. 10, an example in which an additional value α is specified for every 8 brightness difference values is shown. However, it is preferable that the number of brightness difference values for which one additional value α is specified and the value of the additional value α can be changed according to the characteristics etc. of the display panel 20.

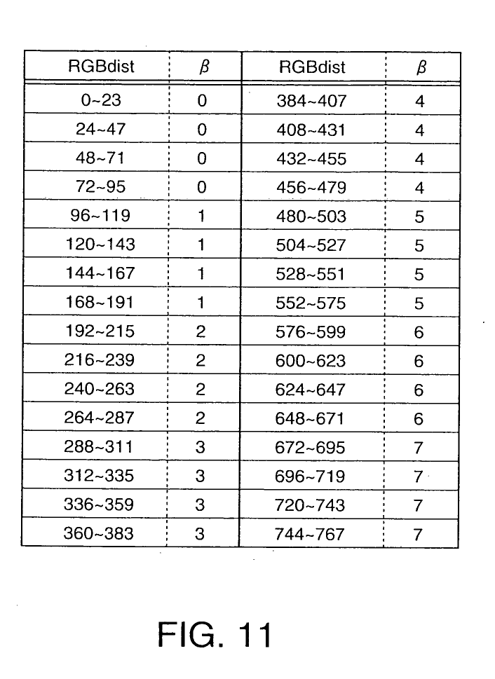

In FIG. 11, an example of the brightness difference frame rate addition table stored in the color distance frame rate addition table storing section 136 of FIG. 3 is schematically shown. In the color distance frame rate addition table, an additional value β is specified for a color distance (RGBdist). Incidentally, in FIG. 11, an example in which an additional value β is specified for every 24 color distance values is shown. However, it is preferable that the number of color distance values for which one additional value β is specified and the value of the additional value β can be changed according to the characteristics etc. of the display panel 20.

At this time, the image processing apparatus 100 is assumed to perform FRC on image data (in which each color component is 8-bit data) in RGB format, the image data of each dot in the following processing block PBK.

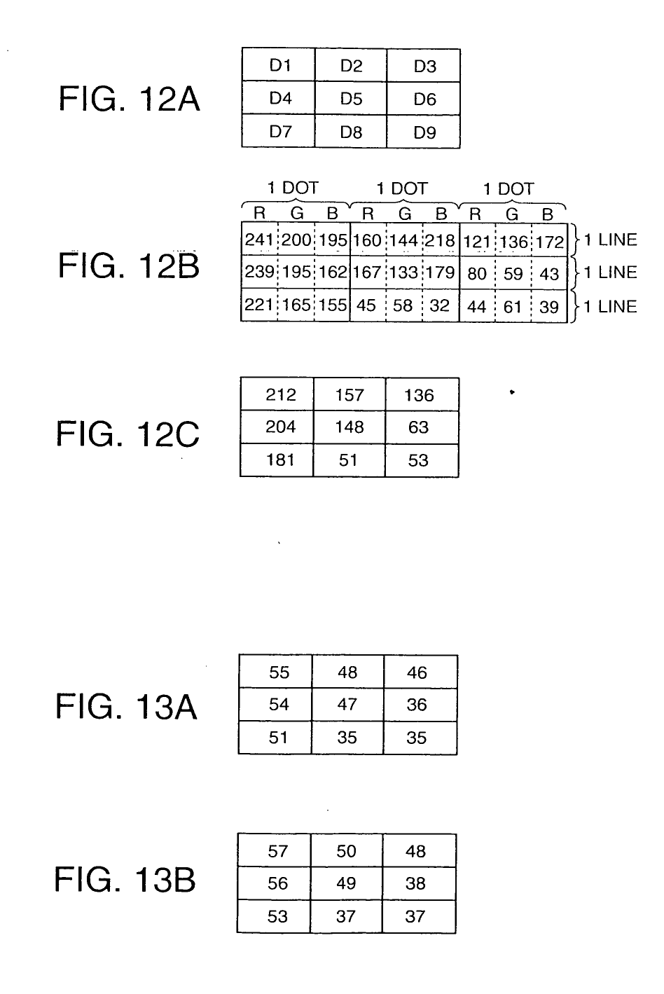

In FIGS. 12(A) to 12(C), a specific example of the brightness obtained for each dot in the processing block PBK is shown. FIG. 12(A) is an explanatory diagram of the processing block PBK. FIG. 12(B) shows an example of image data of the processing block PBK. FIG. 12(C) shows an example of the brightness of the processing block.

In this embodiment, the processing block PBK formed of 3 dots×3 lines includes dots D1 to D9. At this time, a brightness difference and a color distance are calculated with reference to the dot D5. Incidentally, when the processing block PBK is located in an upper-left position in a screen and the coordinates of the dot D5 in the screen (X, Y)=(0, 0), the dots D1, D2, D3, D4, and D7 are assumed to be treated as an exception and processed as the same data as the dot D5.

When the image data of the dot D1 is (R, G, B)=(241, 200, 195), the brightness is obtained by a well-known YUV conversion equation, and Y=212 is got as shown in FIG. 12(C). For the image data of the dots D2 to D9 of FIG. 12(A), the brightness shown in FIG. 12(C) is obtained by a similar YUV conversion equation. Here, the base frame rate generating section 126 obtains a base frame rate fr corresponding to the brightness of each dot by referring to the base frame rate table shown in FIG. 8. Moreover, the base frame rate generating section 126 acquires an additional value δ by referring to the base frame rate addition table shown in FIG. 9 based on the average brightness of the block, and corrects the base frame rate based on the additional value δ.

In FIGS. 13(A) and 13(B), an example of the base frame rate corresponding to the brightness of FIG. 12(C) is shown. FIG. 13(A) shows an example of the base frame rate for each dot, the base frame rate generated by the base frame rate generating section 126. FIG. 13(B) shows an example of the base frame rate for each dot, the base frame rate corrected in the base frame rate generating section 126.

For example, as the base frame rate fr corresponding to Y=212 in the dot D1 shown in FIG. 12(C), 55 is set in the base frame rate table shown in FIG. 8. For the other dots D2 to D9 of the block, the base frame rate generating section 126 also generates the base frame rates by referring to the base frame rate table (FIG. 13(A)). Here, it is assumed that the average brightness of the block is obtained as Yave=134 as a result of rounding. At this time, the base frame rate generating section 126 acquires an additional value δ=2 by referring to the base frame rate addition table shown in FIG. 9 and adds the additional value δ to the base frame rate of each dot of the block, and thereby generates the corrected base frame rate (FIG. 13(B)).

Next, the frame rate adjustment processing section 128 calculates the brightness differences and the color distances between the dot D5 of FIG. 12(A) and the surrounding dots D1 to D4 and D6 to D9. Incidentally, in this embodiment, with consideration given to the processing speed and the size of hardware, the color distance is obtained as the sum total of differences between the color components of RGB.

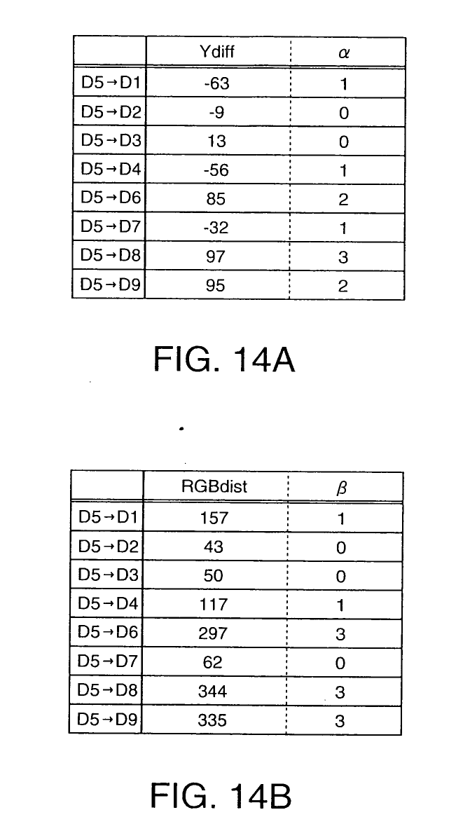

In FIGS. 14(A) and 14(B), an example of the brightness differences and the color distances between the dot D5 and the surrounding dots, the brightness differences and the color distances calculated in the frame rate adjustment processing section 128, is shown. FIG. 14(A) shows an example of the brightness differences between the dot D5 and the surrounding dots and additional values α corresponding to the brightness differences. FIG. 14(B) shows an example of the color distances between the dot D5 and the surrounding dots and additional values β corresponding to the color distances.

When the brightness differences between the dot D5 and the surrounding dots are calculated, the additional values α shown in FIG. 14(A) are obtained for the brightness differences by referring to the brightness difference frame rate addition table shown in FIG. 10. The frame rate adjustment processing section 128 further obtains the amount of adjustment Δα based on the additional values α shown in FIG. 14(A), and performs processing for adjusting the frame rate by using the additional values α and the amount of adjustment Δα. Similarly, when the color distances between the dot D5 and the surrounding dots are calculated, the additional values β shown in FIG. 14(B) are obtained for the color distances by referring to the color distance frame rate addition table shown in FIG. 11. The frame rate adjustment processing section 128 further obtains the amount of adjustment Δβ based on the additional values δ shown in FIG. 14(B), and performs processing for adjusting the frame rate by using the additional values β and the amount of adjustment Δβ.

First, the maximum value of the additional values α corresponding to the brightness differences with negative values, the brightness differences of the brightness differences (Ydiff) shown in FIG. 14(A), is assumed to be al. Here, for the dot D5, the frame rate is adjusted by adding α1=1 to the base frame rate. On the other hand, for the dots D1 to D4 and D6 to D9, it is determined whether or not the average value of the additional values α corresponding to the brightness differences with positive values is greater than (the number of brightness differences with positive values×α1). If the average value is greater than (the number of brightness differences with positive values×α1), 1, for example, is added to the frame rates; if not, 1 is not added thereto. Incidentally, for the dots D1 to D4 and D6 to D9, nothing is added to the frame rate of a dot of the dots D1 to D4 and D6 to D9 if the brightness difference thereof has a negative value. For example, in a case shown in FIG. 14(A), the amount of adjustment Δα which is added to the frame rate is obtained as follows.

$$\begin{matrix}Δα = if ( ( 0 + 2 + 3 + 2 ) / 4 ) > ( α 1 \times 4 ) ) then 1 else 0 \\ = 0\end{matrix}$$

Next, an additional value β corresponding to a color distance of the color distances (RGBdist) shown in FIG. 14(B), the color distance whose absolute value (abs(negative Ydiff×RGBdist)) of the result of multiplication of the brightness difference with a negative value and the color distance becomes a maximum value, is assumed to be β1. Here, for the dot D5, the frame rate is adjusted by adding β1=1 to the base frame rate. On the other hand, for the dots D1 to D4 and D6 to D9, it is determined whether or not the average value of the additional values β corresponding to the brightness differences with positive values is greater than (the number of brightness differences with positive values×β1). If the average value is greater than (the number of brightness differences with positive values×β1), 1, for example, is added to the frame rate; if not, 1 is not added thereto. Incidentally, for the dots D1 to D4 and D6 to D9, nothing is added to the frame rate of a dot of the dots D1 to D4 and D6 to D9 if the brightness difference thereof has a negative value. For example, in a case shown in FIG. 14(B), the amount of adjustment Δβ which is added to the frame rate is obtained as follows.

$$\begin{matrix}Δβ = if ( ( 0 + 3 + 3 + 3 ) / 4 ) > ( β 1 \times 4 ) ) then 1 else 0 \\ = 0\end{matrix}$$

As described above, focusing on the fact that the number of surrounding dots whose brightness differences have positive values correspond to the average luminosity in the processing block, addition is performed, in a plus direction, on the frame rate of a dot which is darker than the average luminosity based on the brightness difference and the color distance. As a result, by reducing the frame rates of dots which are different in brightness in the processing block, it is possible to prevent the difference in brightness from becoming more prominent.

When the amounts of adjustment Δα and Δβ are obtained in the manner described above, the frame rate adjustment processing section 128 generates the frame rates by adjusting the base frame rates of the dots by using the amounts of adjustment Δα and Δβ.

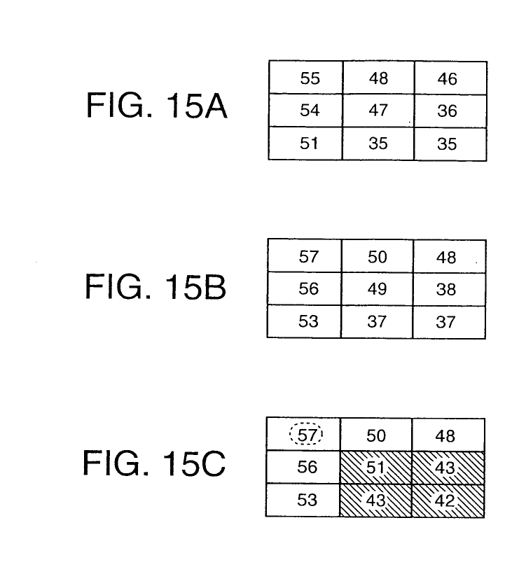

In FIGS. 15(A) to 15(C), an example of the frame rates of the dots, the frame rates generated in the frame rate generating section 124, is shown. FIG. 15(A) shows an example of the base frame rates generated by the base frame rate generating section 126 for the processing block PBK of FIGS. 12(A) to 12(C). FIG. 15(B) shows an example of the base frame rates corrected by the base frame rate generating section 126 for the processing block PBK of FIGS. 12(A) to 12(C). FIG. 15(C) shows an example of the frame rates adjusted by the frame rate adjustment processing section 128 for the processing block PBK of FIGS. 12(A) to 12(C).

When the dots in the processing block PBK have the brightness shown in FIG. 12(A), after the base frame rates are generated for the dots as shown in FIG. 15(A), the base frame rates are corrected as shown in FIG. 15(B) according to the average brightness of the block BK. Then, the frame rates are adjusted as shown in FIG. 15(C) according to the brightness differences and the color distances between the dots adjacent to each other in horizontal, vertical, and oblique directions. At this time, the frame rate adjustment processing section 128 generates the frame rates as follows.

D1=57+(α+Δα)+(β+Δβ)=57+(0+0)+(0+0)=57

D2=50+(α+Δα)+(β+Δβ)=50+(0+0)+(0+0)=50

D3=48+(α+Δα)+(β+Δβ)=48+(0+0)+(0+0)=48

D4=56+(α+Δα)+(β+Δβ)=56+(0+0)+(0+0)=56

D5=49+α1+β1=49+1+1=51

D6=38+(α+Δα)+(β+Δβ)=38+(2+0)+(3+0)=43

D7=53+(α+Δα)+(β+Δβ)=53+(0+0)+(0+0)=53

D8=37+(α+Δα)+(β+Δβ)=37+(3+0)+(3+0)=43

D9=37+(α+Δα)+(β+Δβ)=37+(2+0)+(3+0)=42

Then, the image processing apparatus 100 moves the processing block PBK by one dot in a horizontal direction or by one line in a vertical direction in the image analyzing section 120, and generates the frame rates of the dots in the processing block to which the processing block PBK has been moved. At this time, the image processing apparatus 100 uses, as the base frame rate, the frame rate generated in the last processing block as it is without referring to the table as described earlier. Therefore, when the frame rate of the first processing block is generated and the processing block is moved to the next processing block, only the base frame rate of the dot D1 (the dot having a frame rate of “57” in FIG. 15(C)) is determined. Then, in the next processing block to which the processing block has been moved, the dot D2 (the dot having a frame rate of “50” in FIG. 15(C)), for example, is processed as a dot at the upper-left corner of the next processing block, and the frame rate of the dot at the upper-left corner is determined. In this way, when scanning of the processing blocks in the image is completed, the frame rates of all the dots are determined.

Moreover, it is preferable to perform gamma correction processing, as shown in FIG. 2, on the image data subjected to FRC according to the determined frame rates. In this case, even if there is a decrease in the brightness of the whole image or color loss occurs, it is possible to prevent deterioration of image quality.

The display system 10 including the image processing apparatus 100 described above can be applied to the following electronic apparatus, for example.

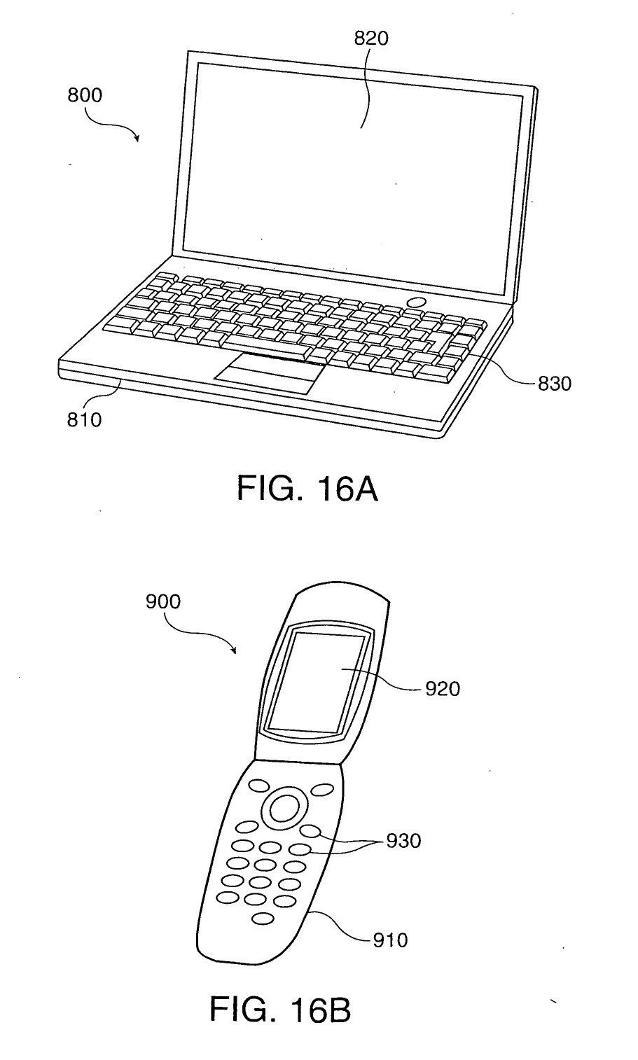

In FIGS. 16(A) and 16(B), perspective views showing the configurations of electronic apparatuses to which the display system 10 in this embodiment is applied are shown. FIG. 16(A) is a perspective view of the configuration of a mobile personal computer. FIG. 16(B) is a perspective view of the configuration of a mobile telephone.

A personal computer 800 shown in FIG. 16(A) includes a main body section 810 and a display section 820. As the display section 820, the display system 10 in this embodiment is implemented. The main body section 810 includes the host 200 of the display system 10, and a keyboard 830 is provided in the main body section 810. That is, the personal computer 800 includes at least the image processing apparatus 100 in the embodiment described above. The operating information via the keyboard 830 is analyzed by the host 200, and an image is displayed in the display section 820 according to the operating information. Since the display section 820 uses an OLED as a display element, it is possible to provide the personal computer 800 with a screen having a wide viewing angle.

A mobile telephone 900 shown in FIG. 16(B) includes a main body section 910 and a display section 920. As the display section 920, the display system 10 in this embodiment is implemented. The main body section 910 includes the host 200 of the display system 10, and a keyboard 930 is provided in the main body section 910. That is, the mobile telephone 900 includes at least the image processing apparatus 100 in the embodiment described above. The operating information via the keyboard 930 is analyzed by the host 200, and an image is displayed in the display section 920 according to the operating information. Since the display section 920 uses an OLED as a display element, it is possible to provide the mobile telephone 900 with a screen having a wide viewing angle.

Incidentally, an electronic apparatus to which the display system 10 in this embodiment is applied is not limited to those shown in FIGS. 16(A) and 16(B). For example, some examples of such an apparatus are personal digital assistants (PDAs: Personal Digital Assistants), digital still cameras, televisions, video cameras, car navigation devices, pagers, electronic organizers, electronic paper, calculators, word processors, workstations, video telephones, POS (Point of sale system) terminals, printers, scanners, copiers, video players, and apparatuses provided with a touch panel.

The image processing apparatus, the display system, the electronic apparatus, the method of processing an image, etc. according to the invention have been described based on the embodiment described above; however, the invention is not limited by the embodiment described above. For example, the invention can be implemented in numerous ways within the scope of the subject matter of the invention, and the following modifications are possible.

(1) In this embodiment, descriptions have been given by taking up, as an example, the display system to which an OLED is applied; however, the invention is not limited by this example.

(2) In this embodiment, an example in which the color distance is obtained as the sum total of differences between the color components of RGB has been described; however, the invention is not limited by this example. For example, the color distance between dots may be obtained as a difference in chromaticity by performing conversion from image data into chromaticity according to a well-known chromaticity conversion equation.

(3) In this embodiment, the invention has been described as an image processing apparatus, a display system, an electronic apparatus, a method of processing an image, etc.; however, the invention is not limited thereto. For example, the invention may be a program product in which the procedure of the above-described method of processing an image is described or a recording medium in which the program product is recorded.

1. An image processing apparatus performing frame rate control on image data corresponding to each of dots forming a display image, comprising:
a frame rate generating section generating a frame rate of a dot according to a difference in gradation between the dot and at least one dot around the dot; and
a frame rate control section performing frame rate control on the image data on a dot-by-dot basis based on the frame rate generated by the frame rate generating section.

2. The image processing apparatus according to claim 1, wherein
the frame rate generating section includes a frame rate adjustment processing section adjusting the frame rate based on at least one of a difference between the brightness of the dot and the brightness of a dot around the dot and a difference between the color value of the dot and the color value of a dot around the dot.

3. The image processing apparatus according to claim 1, wherein
the frame rate generating section corrects the frame rate of the dot, the frame rate generated according to the difference in gradation, in accordance with average brightness of blocks forming a plurality of blocks into which the display image is divided.

4. The image processing apparatus according to claim 1 wherein
the frame rate generating section generates the frame rate of the dot according to the difference in gradation between the dot and a dot around the dot while performing scanning corresponding to one screen on a processing block-by-processing block basis, a processing block being formed of three dots in a horizontal direction and three dots in a vertical direction of the display image, in the horizontal direction and in the vertical direction.

5. The image processing apparatus according to claim 1, wherein
the frame rate control section performs frame rate control on the image data on a dot-by-dot basis when the display image is a still image.

6. The image processing apparatus according to claim 1 comprising:
a gamma correction processing section performing gamma correction processing on the image data on which frame rate control has been performed by the frame rate control section.

7. A display system, comprising:
a display panel including a plurality of row signal lines, a plurality of column signal lines provided so as to intersect the plurality of row signal lines, and a plurality of light emitting devices, each being identified by any one of the plurality of row signal lines and any one of the plurality of column signal lines and emitting light at brightness according to a drive current;
a row driver driving the plurality of row signal lines;
a column driver driving the plurality of column signal lines; and
the image processing apparatus according to claim 1,
wherein
the display system displays the display image based on the image data on which frame rate control has been performed by the image processing apparatus.

8. An electronic apparatus, comprising:
the image processing apparatus according to claim 1.

9. A method of processing an image, the method by which frame rate control is performed on image data corresponding to each of dots forming a display image, comprising:
a frame rate generating step of generating a frame rate of a dot according to a difference in gradation between the dot and at least one dot around the dot; and
a frame rate control step of performing frame rate control on the image data on a dot-by-dot basis at the frame rate generated in the frame rate generating step.

10. The method of processing an image according to claim 9, wherein
in the frame rate generating step,
the frame rate is adjusted based on at least one of a difference between the brightness of the dot and the brightness of a dot around the dot and a difference between the color value of the dot and the color value of a dot around the dot.

11. The method of processing an image according to claim 9, wherein
in the frame rate generating step,
the frame rate of the dot, the frame rate generated according to the difference in gradation, is corrected in accordance with average brightness of blocks forming a plurality of blocks into which the display image is divided.

12. The method of processing an image according to claim 9, wherein
in the frame rate generating step,
the frame rate of the dot is generated according to the difference in gradation between the dot and a dot around the dot while performing scanning corresponding to one screen on a processing block-by-processing block basis, a processing block being formed of three dots in a horizontal direction and three dots in a vertical direction of the display image, in the horizontal direction and in the vertical direction.
